(19) United States
(12) Patent Application Publication
(10) Pub. No.: US 2012/0111444 A1
(43) Pub. Date: May 10, 2012

(54) FILL PORT FOR ELECTRIC VEHICLE BATTERY ENCLOSURE

(75) Inventors: Weston A. Hermann, Palo Alto, CA (US); Kurt R. Kelty, Palo Alto, CA (US)

(73) Assignee: TESLA MOTORS, INC., Palo Alto, CA (US)

(21) Appl. No.: 12/942,465

(22) Filed: Nov. 9, 2010

(51) Int. Cl. H01M 10/42; H01M 2/12; H01M 10/04; H01M 10/50

(52) U.S. Cl. 141/1.1; 429/120; 429/53; 29/623.1

(57) ABSTRACT

An apparatus and method providing for coolant agent ingress of a high energy density battery enclosure during an internal thermal event. A solution includes a specialized battery enclosure and, in some embodiments, an associated vehicle structure providing a normally closed, pressure activated fill port. Preferably the fill port is positioned so an operator of the fill port is clear from any hot gases exiting from the enclosure.

### BACKGROUND OF THE INVENTION

The present invention relates generally to fluid ingress into an electric vehicle battery enclosure, and more particularly to a fill port access system permitting efficient application of water inside the enclosure in order to control any excessive thermal condition of the individual battery cells and modules.

Battery packs used with electric vehicles store large amounts of energy in a small space, producing high energy densities. These battery packs include an external housing that is designed for more than just environmental protection and packaging efficiency. The housing also enhances safety and stability, particularly under a range of anticipated abnormal operating conditions.

The battery packs are designed to provide high levels of safety and stability, yet situations can arise where a portion of a battery pack experiences a “short-circuit” condition which releases energy as heat. This short-circuit can occur from failure of a battery cell or from mechanical damage, such as a collision that damages an internal arrangement of cells of the battery pack.

The heat released from the short-circuit can be great enough, depending upon many factors including an amount of energy being converted and location of the short-circuit, to initiate a chain reaction. The chain reaction results from a heating of adjacent cells, which can cause them to overheat and fail, releasing heat that, in turn, propagates throughout the battery back.

Once the reaction starts, it can continue to spread throughout the battery pack or a portion thereof until overheating cells are sufficiently cooled or the entire battery pack or the portion is consumed. A typical battery pack has a high thermal mass, mostly due to the mass of the cells. A failure of an individual cell provides for a relatively low energy release. Also, surrounding battery cells must be heated to as much as 200° C. or higher before they in turn release energy. These three factors mean that a full reaction that consumes all the cells of a battery pack may take anywhere from tens of minutes to many hours.

A conventional solution for a problem of an initiated chain reaction is to simply permit, once passengers and bystanders are clear of the vehicle, the reaction is allowed to run its course. While this situation is rare and designs are implemented to continue to make such situations ever more unlikely, there are some situations where it may be advantageous to terminate the reaction early (particularly to terminate additional heat release at will).

There are several factors that add to the challenges of early termination of such a reaction. One of these factors is the external housing. The housing has been engineered to resist structural corruption, by venting internally generated gases and resisting damage to the housing integrity from mechanical impacts/damage. The housing also provides environmental protection from water/moisture ingress. To do this, the housing is particularly engineered as a sealed, strong, metallic or fiber-reinforced polymer enclosure. To mitigate/extinguish an internal short-circuit reaction by application of any externality (e.g., water or heat-removing agents) directly to the outside of the housing is largely ineffective because the housing prevents the externality from direct contact with the cells.

It is further difficult to control the chain reaction because oxygen is released from some battery cathode materials during these reactions making it difficult to control the reaction by removing oxygen. The most effective way to control/limit potential and actual multiple-cell thermal runaway scenarios is to remove excess heat inducing reactions in other cells and, because of the large thermal mass, the best way to remove heat is for there to be direct contact between the affected cells and the heat-removing agent.

Issues surrounding the internal layout of the battery cells, protecting against accidental electrical energy release, ensuring safety from hot gas exhaust, and properly locating any solution within an electric vehicle form factor (among other considerations) make it a challenge to produce an acceptable solution.

What is needed is an apparatus and method for providing coolant agent ingress of a high energy density battery enclosure during an internal thermal event.

### BRIEF SUMMARY OF THE INVENTION

Disclosed is an apparatus and method providing for coolant agent ingress of a high energy density battery enclosure during an internal thermal event. A solution includes a specialized battery enclosure and, in some embodiments, an associated vehicle structure providing a normally closed, pressure activated fill port. Preferably the fill port is positioned so an operator of the fill port is clear from any hot gases exiting from the enclosure.

A fill-enabled battery enclosure system for a high energy battery pack, the system includes a thermal-control-agent-retaining enclosure of a traction battery pack having a plurality of interconnected batteries with the enclosure reinforced for mechanical protection of the batteries when installed in an electric vehicle; and a fill port coupled to a portion of a wall of the enclosure, the fill port including a selectably permeable obstruction allowing an ingress of a thermal-control agent into the enclosure through the fill port while largely inhibiting an egress of a gas out of the enclosure through the fill port.

A fill-enabled battery enclosure system for a high energy battery pack, the system includes an electric vehicle including a chassis and a body; a thermal-control-agent-retaining enclosure of a traction battery pack including a plurality of interconnected batteries with the enclosure reinforced for mechanical protection of the batteries when installed in the electric vehicle; and a fill port coupled to a portion of a wall of the enclosure, the fill port including a selectably permeable obstruction allowing an ingress of a thermal-control agent into the enclosure through the fill port while inhibiting an egress of a gas out of the enclosure through the fill port.

A method, the method including a) inhibiting an egress of a gas out of an enclosure through a fill port using a selectively permeable obstruction of the fill port, the enclosure including a thermal-control-agent-retaining enclosure of a traction battery pack including a plurality of interconnected batteries with the enclosure reinforced for mechanical protection of the batteries when installed in an electric vehicle with the fill port coupled to a portion of a wall of the enclosure; and b) allowing an ingress of a thermal-control agent into the enclosure through the fill port while inhibiting the egress of the gas.

Features/benefits include an ability to terminate/mitigate a runaway thermal condition inside a battery enclosure for a high energy battery pack, such as the type used in electric vehicles and similar applications. Other features, benefits, and advantages of the present invention will be apparent upon a review of the present disclosure, including the specification, drawings, and claims.

### BRIEF DESCRIPTION OF THE DRAWINGS

FIG. 1 is a schematic block diagram illustrating a preferred embodiment of the present invention.

### DETAILED DESCRIPTION OF THE INVENTION

Embodiments of the present invention include an apparatus and method providing for coolant agent ingress of a high energy density battery enclosure during an internal thermal event. The following description is presented to enable one of ordinary skill in the art to make and use the invention and is provided in the context of a patent application and its requirements. In the following text, the terms “energy storage system”, “energy storage assembly”, “battery”, “cell”, “brick”, “battery cell”, “battery cell pack”, “pack” “electrolytic double-layer capacitor”, and “ultracapacitor” may be used interchangeably (unless the context indicates otherwise) and may refer to any of a variety of different rechargeable configurations and cell chemistries described herein including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other chargeable high energy storage type/configuration. A context for one implementation is use of rechargeable Li-ion battery packs designed for plug-in electric vehicles (PHEV, HEV, and EV and the like), though other industrial applications for such high-energy battery packs may implement variations to the invention described herein without departing from the present invention.

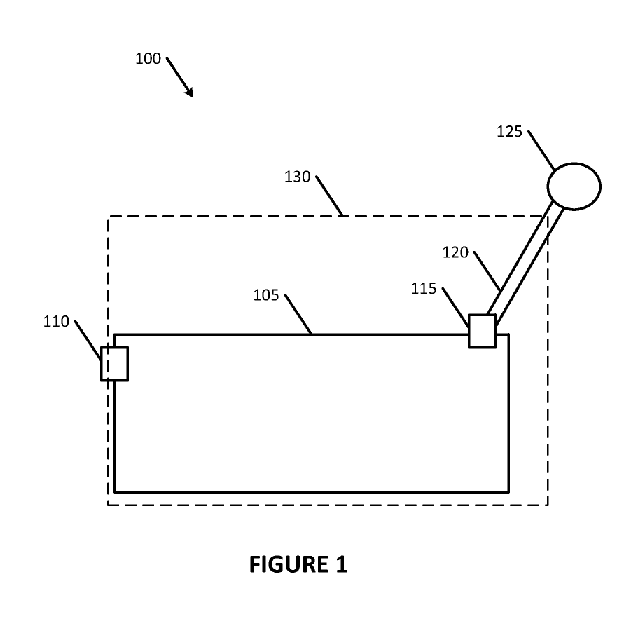

FIG. 1 is a schematic block diagram illustrating a preferred embodiment of the present invention for a Tillable battery enclosure system 100. System 100 includes an enclosure 105 for a high electric energy density storage system. Enclosure 105 includes one or more exit vents 110 and one or more fill ports 115. As explained further herein, fill port 115 may include a fill port coupler made up of a passageway 1120 and an externally accessible port 125. System 100 of the preferred embodiment is incorporated into, and includes in some implementations, a passenger vehicle 130.

Enclosure 105 is preferably a sealed, rugged metallic case that provides the structural, environmental, and safety protections of the battery pack. Not shown are the many internal energy storage elements that make up the energy storage characteristic of the pack. While the specifics of battery pack design will vary, the following description is provided to simplify a discussion of the present invention.

Each cell used in the battery includes a small form factor battery cell, an 18650 cell, which is just a bit larger than a AA battery. Due to its small size, any single cell contains a limited amount of energy. The battery pack includes about 6800 of these 18650 cells, and the entire pack has a mass of about 450 kg.

The cells also incorporate numerous mechanical, thermal, and chemical factors that contribute to their safety in a battery pack. For example, cells used in some battery packs are all packaged in steel cans. This feature offers multiple safety benefits. From a mechanical standpoint, the steel case of each cell provides structural rigidity and strength. This helps dissipate extreme mechanical loading as well as providing protection against objects penetrating or compressing a cell and thereby shorting it. From a thermal standpoint, the steel case also offers good thermal conductivity and control of gas released during a failure. The dissipation of heat from a cell both extends battery life and helps maintain the pack at an even temperature. From a chemical and materials standpoint, the materials used in the cell's construction can greatly impact the flammability and initiation temperature of thermal runaway.

Due to the size and weight of the battery pack, there is an opportunity to add many more safety features than can be contained in other configurations, such as a laptop battery pack. Overall, some of these battery pack safety features are active and others are passive. Some are mechanical and others are electrical. For example, the battery pack is controlled internally by several embedded microprocessors that operate both when the battery pack is installed in the vehicle. An example of a passive safety feature is the selection of aluminum or steel for the battery pack enclosure instead of plastic as in laptop battery packs. The aluminum or steel provides greater structural strength in case of mechanical abuse tolerance and does not easily melt or burn.

Architecturally, the battery pack includes eleven battery modules, a main control and logic PCB (printed circuit board), and a 12V DC-DC power supply. Each of the eleven modules carries a monitoring PCB (with its own microprocessor) that communicates with the rest of the vehicle microcontrollers, broadcasting the voltage and temperature measurements of its module over a standard CAN bus.

There are tubes and a manifold as part of the enclosure (not shown) that extend out of the battery pack. During operation, these are used to circulate a cooling fluid (a 50/50 mix of water and glycol) throughout the pack via sealed fluid paths isolated from the cells themselves. This enables the cells of the pack to be kept thermally balanced, and extends the life of the battery pack while also having numerous safety benefits.

This cooling system design is especially effective because it combines thousands of small cells rather than several large ones to build the battery pack dramatically increasing the surface to volume ratio. Surface area is essential to cooling batteries since the surface is where heat is removed; more is better. Also, because of their small size, each cell is able to quickly redistribute heat within, and shed heat to, the cooling system making it essentially isothermal. This cooling architecture avoids “hot spots” which can lead to failures in battery modules with larger cells.

The microprocessors, logic circuitry and sensors are continually monitoring voltages, currents and temperatures within the pack. These sensors also monitor inertia acceleration (e.g. to detect a crash) and vehicle orientation to the ground (e.g. to detect a rollover). The battery packs also include humidity, and moisture sensors. Should certain sensors exceed the specified range, then high voltage contactors will immediately (within milliseconds) disconnect the high voltage of the battery pack from the car. The battery pack design incorporates an array of passive safety features as well. The passive design improves the robustness of the battery pack, particularly against mechanical damage and potential foreign object penetration of the battery pack.

None of the battery pack's high voltage systems are accessible to accidental contact outside their protective enclosures and jacketed cables. Only with special tools can someone gain access to any high-voltage components. The high-voltage systems are enclosed, labeled, and color coded with markings that service technicians and first responders already understand.

Finally, the battery pack enclosure is designed to contain all the battery modules, fuses, bus bars, and safety circuitry of the system. The enclosure is electrically isolated from the battery pack and prevents users from directly accessing any high voltage connections. The enclosure is also designed to withstand substantial abuse in the vehicle, including collision, while maintaining the integrity of the battery modules and circuitry inside.

So much of the design of the sealed enclosure is specifically intended to resist simple ingress of a thermal-control agent (e.g., water or the like), therefore purposeful ingress and effective distribution of such an agent in an urgent situation by a party unfamiliar with assembly and operation of a battery pack is challenging. The design of system 100 is intended to address such a situation and to fulfill such needs. To enhance readability, the rest of the disclosure will refer to the thermal-control agent as water since water is the preferred agent of choice in the present scenario. However, other suitable thermal-control agents may be used without departing from the spirit of the invention.

It becomes difficult to externally force the water into sealed enclosure 105 in order to surround and cool any overheated or overheating cell. Traditional battery pack design includes pressure equalization vents that help to reduce enclosure stress during changes in ambient pressure. Often such vents are bi-directional valves that operate at about 1 psi. Vent 110 may use such valves but preferably is a specialized design to facilitate the present invention. For example, vent 110 is preferred to accommodate any hot gases that could be generated during a thermal event addressed by system 110. The accommodation includes allowing for egress of the hot gases in such a way to reduce risks to passengers, first responders, and persons surrounding vehicle 130. For example, vent 110 could be coupled to, or incorporated into, a metal duct that conveys any hot gases outside an envelope of vehicle 130. In some embodiments, there will be separate vents for atmospheric equalization and hot gas release. For example, hot gas release vents may open wider in response to excessive pressure and/or heat. As used herein, valve is an expansive term including devices, active or passive, for controlling flow of fluids (e.g., water or gas or the like).

Additionally, one or more vents 110 are positioned to permit egress of any internal gas that is displaced by the addition of water into enclosure 130. Vents 110 serving this purpose are arranged in strategic locations to permit almost complete evacuation of internal gas (and therefore complete filling of enclosure 105 with water) although some implementations may use a single appropriately located vent. That vehicle 130 may have different orientations, vents 110 are positioned in anticipation of some of the possible orientations to permit sufficiently complete evacuation while in these orientations. It is preferred that enclosure 105, when possible, be able to retain distributed water throughout. Therefore vents 110 are preferably implemented to allow gases to escape while inhibiting water egress.

Fill port 115 is designed to allow unidirectional ingress of water into enclosure 105 while inhibiting egress of gases from enclosure 105. There are many different ways that this may be achieved, typically by use of some form of selectively permeable obstruction. For example, fill port 115 may include a pressure valve that resists backflow (i.e., out of enclosure 105) while opening in response to sufficient positive pressure. The valve opening permits water to flow into enclosure 105. It is desirable that fill port 115 be configured to respond to the typical level of water pressure that is able to be generated by first responders and the like. Alternatively a burst disk may be used as the selectively permeable obstruction that ruptures in response to sufficient pressure while retaining internal gases.

In another example, the selectably permeable obstruction may simply include a specially designed region in a wall of enclosure 105 that has been mechanically weakened. It is not sufficiently weakened that is unable to resist rupture from internal gas pressure, however it is configured to open in response to application of sufficient external water pressure.

As representative numbers, the types of pressure that may be used for actuation of fill port 115 is a range of 10-50 psi. Of course other ranges, such as 20-100 psi or 30-80 psi may be more appropriate (currently many new firetrucks are able to easily generate 100 psi). The actuation pressure should be set according to be greater than a maximum expected differential pressure between the inside and the outside of enclosure 105, but less than water pressure commonly available to the relevant first responders.

In some scenarios, enclosure 105 will be mounted to a chassis of vehicle 130 which would often make a surface mounted fill port 115 inaccessible. In some cases it may be possible to remove a concealing panel or cosmetic covering to allow access to such a fill port 115. However, in some cases fill port 115 will include the coupler made up passageway 120 and externally available port 125. Such a configuration provides more flexibility in locating vent 110 and port 115.

With the coupler, it is contemplated that externally accessible port 125 is positioned for most convenience to potential users and passageway 120 provides a channel to communicate the water from the user into enclosure 105. In such a case, the selectably permeable obstruction may be incorporated into passageway 120 and/or port 125 when necessary and/or desirable. Also, with such a solution, it may be the situation that passage 120 and/or port 125 could be integrated into a structure of vehicle 130 with passageway 120 assembled and sealed to enclosure 105 when the battery pack is installed into vehicle 130.

While use of the coupler extends the scenarios by which the embodiments of the present invention may be used, it is still the case that port 125 may be desirably concealed. For example it may be desirable/necessary to conceal port 125 (or fill port 115) behind a hatch or section of a body panel. In some cases, a cap may be used to cover an opening, and in some cases the cap may require a special tool or key in order to be opened.

In some implementations, it is desirable to provide for multiple access points into enclosure 105. Depending upon location and vehicle orientation, there are situations where use of a single port may result in port blockage/damage/nonfunctioning status. Thus it is the case that some implementations use multiple locations for ports 115 and/or ports 125. As noted above, the ports, when accessed, should be located as far as possible from vents 110 that may eject hot gases. There are many considerations for placement of ports 115/125, including safety of, convenience for, and accessibility by persons using the ports. Some candidate locations for the ports include positions behind and above front wheel wells, trunk, and between the front seats inside the passenger compartment. Factors to consider include safety for the responders, accessibility during anticipated vehicle orientations, and likelihood of damage.

It is a further feature of some embodiments to provide for latching/locking of water dispensing systems to port 115/125. One way to do this is to include a standard fitting complementary to a type of water dispensing systems frequently used by first responders. These may be 2 or 2.5 inch fittings with NHS thread, for example. Alternatively a smaller diameter may be used, particularly if a smaller size were standardized and adopted by enclosure/vehicle manufacturers. Virtually any fitting design may be used.

In operation, when it is desired to provide water inside enclosure 105, port 125 is accessed. The access may include opening a hatch or removing a panel or other cosmetic device to make port 125 externally accessible. Furthermore, in those situations in which a cap is used to cover, protect, and/or lock passageway 120, that cap is removed. A special tool or key may need to be used to facilitative this removal step.

A hose or other dispensing system is fitted to complementary fittings of port 125 and water dispensation is initiated. As water flows into passageway 120, water pressure builds up until a sufficient pressure exists to trigger the selectably permeable obstruction (e.g., valve or plate or the like) that allows egress of the water into enclosure 105. As water flows into enclosure 105, some of the internal gases are displaced and exit from vent 110. Water continues to be dispensed until all the applicable cells are cooled by water. The water cools any hot spots and quickly suspends any potential or actual runaway thermal events.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A fill-enabled battery enclosure system for a vehicle battery pack, the system comprising:
a thermal-control-agent-retaining enclosure of a traction battery pack including a plurality of interconnected batteries with said enclosure reinforced for mechanical protection of said batteries when installed in an electric vehicle; and
a fill port coupled to a portion of a wall of said enclosure, said fill port including a selectably permeable obstruction allowing an ingress of a thermal-control agent into said enclosure through said fill port while inhibiting an egress of a gas out of said enclosure through said fill port.

2. The system of claim 1 wherein said thermal-control agent is a fluid.

3. The system of claim 2 wherein said fluid includes a major portion of H₂0.

4. The system of claim 1 wherein said obstruction includes a pressure-actuated valve.

5. The system of claim 4 wherein said pressure-actuated valve opens upon application of an ingress force applied to said valve from outside said enclosure and remains closed upon application of an egress force applied to said valve from inside said enclosure.

6. The system of claim 5 wherein said ingress force is in a range of about 3-100 psi, and more desirably in a range of about 10-50 psi and wherein said egress force is less than said ingress force.

7. The system of claim 1 wherein said obstruction includes a mechanically-weakened access plate.

8. The system of claim 7 wherein said plate breaks opens upon application of an ingress force applied to said valve from outside said enclosure and remains closed upon application of an egress force applied to said plate from inside said enclosure.

9. The system of claim 8 wherein said ingress force is in a range of about 3-100 psi, and more desirably in a range of about 10-50 psi and wherein said egress force is less than said ingress force.

10. The system of claim 8 wherein said ingress force is in a range of about 3-100 psi, and more desirably in a range of about 20-80 psi and wherein said egress force is less than said ingress force.

11. The system of claim 1 wherein said fill port includes a mechanical fitting interoperable with first responder thermal-control-agent dispensing systems.

12. The system of claim 11 wherein said mechanical fitting includes a fastener with NHS threads.

13. The system of claim 11 wherein said mechanical fitting includes a mechanical interlock to secure an element of said dispensing system to said mechanical fitting permitting application of said ingress force to said fill port by dispensation of said thermal-control agent through said mechanical fitting.

14. The system of claim 1 further comprising an exit valve coupled to a second portion of said wall of said enclosure wherein said exit valve provides for egress of gas displaced by ingress of said thermal-control agent.

15. The system of claim 14 wherein said second portion of said wall includes a location permitting egress of a sufficient volume of said internal gas so said internal gas does not prevent thermal control of any internal battery cell by said thermal-control agent provided inside said enclosure through said fill port.

16. The system of claim 1 further comprising a first exit valve coupled to a second portion of said wall of said enclosure wherein said exit valve provides for egress of a hot gas generated during a sustained thermal event of said plurality of batteries, said second portion of said wall displaced from said fill port sufficiently to reduce exposure of an operator of said fill port to said hot gas.

17. The system of claim 16 wherein said first exit valve provides for egress of gas displaced by ingress of said thermal-control agent.

18. The system of claim 16 further comprising a second exit valve coupled to a third portion of said wall of said enclosure wherein said second exit valve provides for egress of gas displaced by ingress of said thermal-control agent.

19. A fill-enabled battery enclosure system for a vehicle battery pack, the system comprising:
an electric vehicle including a chassis and a body;
a thermal-control-agent-retaining enclosure of a traction battery pack including a plurality of interconnected batteries with said enclosure reinforced for mechanical protection of said batteries when installed in said passenger electric vehicle; and
a fill port coupled to a portion of a wall of said enclosure, said fill port including a selectably permeable obstruction allowing an ingress of a thermal-control agent into said enclosure through said fill port while inhibiting an egress of a gas out of said enclosure through said fill port.

20. The system of claim 19 wherein said enclosure is coupled to said chassis and wherein said fill port is structurally isolated from access external to said vehicle.

21. The system of claim 20 wherein said fill port further comprises a fill port coupler, said coupler including an externally accessible port and a passageway communicating said externally accessible port to said enclosure.

22. The system of claim 21 wherein said thermal-control agent is a fluid.

23. The system of claim 22 wherein said fluid includes a major portion of H₂0.

24. The system of claim 21 wherein said obstruction includes a pressure-actuated valve.

25. The system of claim 24 wherein said pressure-actuated valve opens upon application of an ingress force applied to said valve from outside said enclosure and remains closed upon application of an egress force applied to said valve from inside said enclosure.

26. The system of claim 25 wherein said ingress force is in a range of about 3-100 psi, and more desirably in a range of about 10-50 psi and wherein said egress force is less than said ingress force.

27. The system of claim 21 wherein said obstruction includes a mechanically-weakened access plate.

28. The system of claim 27 wherein said plate breaks opens upon application of an ingress force applied to said valve from outside said enclosure and remains closed upon application of an egress force applied to said plate from inside said enclosure.

29. The system of claim 28 wherein said ingress force is in a range of about 3-100 psi, and more desirably in a range of about 10-50 psi and wherein said egress force is less than said ingress force.

30. The system of claim 28 wherein said ingress force is in a range of about 3-100 psi, and more desirably in a range of about 20-80 psi and wherein said egress force is less than said ingress force.

31. The system of claim 21 wherein said fill port includes a mechanical fitting interoperable with first responder thermal-control-agent dispensing systems.

32. The system of claim 31 wherein said mechanical fitting includes a fastener with NHS threads.

33. The system of claim 31 wherein said mechanical fitting includes a mechanical interlock to secure an element of said dispensing system to said mechanical fitting permitting application of said ingress force to said fill port by dispensation of said thermal-control agent through said mechanical fitting.

34. The system of claim 21 wherein said externally accessible port is cosmetically concealed in an externally accessible surface of said passenger vehicle.

35. The system of claim 19 further comprising an exit valve coupled to a second portion of said wall of said enclosure wherein said exit valve provides for egress of gas displaced by ingress of said thermal-control agent.

36. The system of claim 35 wherein said second portion of said wall includes a location permitting egress of a sufficient volume of said internal gas so said internal gas does not prevent thermal control of any internal battery cell by said thermal-control agent provided inside said enclosure through said fill port.

37. The system of claim 19 further comprising a first exit valve coupled to a second portion of said wall of said enclosure wherein said exit valve provides for egress of a hot gas generated during a sustained thermal event of said plurality of batteries, said second portion of said wall displaced from said fill port sufficiently to reduce exposure of an operator of said fill port to said hot gas.

38. The system of claim 37 wherein said first exit valve provides for egress of gas displaced by ingress of said thermal-control agent.

39. The system of claim 37 further comprising a second exit valve coupled to a third portion of said wall of said enclosure wherein said second exit valve provides for egress of gas displaced by ingress of said thermal-control agent.

40. The system of claim 21 wherein said passenger vehicle includes a first orientation having said fill port externally accessible and said passenger including a second orientation having said fill port blocked from external access, said system further comprising a second fill port coupled to a second portion of said wall of said enclosure, said second fill port including a second selectably permeable obstruction allowing an ingress of a thermal-control agent into said enclosure through said second fill port while inhibiting an egress of a gas out of said enclosure through said second fill port wherein said second fill port is structurally isolated from access external to said vehicle wherein said second fill port further comprises a second fill port coupler, said second coupler including a second externally accessible port and a second passageway communicating said second externally accessible port to said enclosure while said passenger vehicle is in said second orientation.

41. A manufacturing method for a fill-enabled battery enclosure system for a vehicle battery pack, the method comprising the steps of:
a) enclosing the vehicle battery pack within a thermal-control-agent-retaining enclosure of a traction battery pack including a plurality of interconnected batteries with said enclosure reinforced for mechanical protection of said batteries when installed in an electric vehicle; and
b) providing access to an interior of said enclosure through a fill port coupled to a portion of a wall of said enclosure, said fill port including a selectably permeable obstruction allowing an ingress of a thermal-control agent into said enclosure through said fill port while inhibiting an egress of a gas out of said enclosure through said fill port.

42. A method for filling a fill-enabled battery enclosure system for a vehicle battery pack, the method comprising the steps of:
a) accessing a thermal-control-agent-retaining enclosure of a traction battery pack including a plurality of interconnected batteries with said enclosure reinforced for mechanical protection of said batteries when installed in an electric vehicle; and
b) filling said enclosure through a fill port coupled to a portion of a wall of said enclosure, said fill port including a selectably permeable obstruction allowing an ingress of a thermal-control agent into said enclosure through said fill port while inhibiting an egress of a gas out of said enclosure through said fill port.
